(19) United States
(12) Patent Application Publication
(10) Pub. No.: US 2009/0158362 A1
(43) Pub. Date: Jun. 18, 2009

(54) Method and apparatus for provisioning media assets at edge locations for distribution to subscribers in a hierarchical on-demand media delivery system

(75) Inventor: George W. Kajos, Westborough, MA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/954,423

(22) Filed: Dec. 12, 2007

(51) Int. Cl. H04N 7/173

(52) U.S. Cl. 725/91

(57) ABSTRACT

An on-demand system is provided that includes a plurality of content storage nodes each having a content server on which reside media assets available to subscribers upon request. The system also includes at least one edge node in communication with the plurality of content storage nodes over a packet-switched network. The edge node is configured to provide on-demand services to the subscribers over an access network. A content management agent is associated with the edge node. The content management agent is configured to coordinate delivery to the edge node of any missing pieces of a media asset streamed to the edge node in response to a subscriber request.

### FIELD OF THE INVENTION

The present invention relates generally to on-demand media delivery systems such as video on-demand media delivery systems for providing content to subscribers, and more particularly to an on-demand media delivery system in which the content is provided to subscribers from edge devices that acquire the programming from geographically distributed servers.

### BACKGROUND OF THE INVENTION

A television may access programming content through a variety of transmission technologies such as cable, satellite, or over the air, in the form of analog or digital signals. Such programming may be delivered in accordance with a number of media delivery models including broadcast, multicast and narrowcast models. In addition to the aforementioned technologies, the Internet is emerging as a television content transmission medium. Television that receives content through an Internet network connection via the Internet Protocol (IP) may be generically referred to as IPTV. The Internet network may be the public Internet, a private network operating in accordance with the Internet Protocol, or a combination thereof. IPTV has become a common denominator for systems in which television and/or video signals are distributed to subscribers over a broadband connection using the Internet protocol. In general, IPTV systems utilize a digital broadcast signal that is sent by way of a broadband connection and a set top box (“STB”) that is programmed with software that can handle subscriber requests to access media sources via a television connected to the STB. A decoder in the STB handles the task of decoding received IP video signals and converting them to standard television signals for display on the television. Where adequate bandwidth exists, IPTV is capable of a rich suite of services compared to cable television or the standard over-the-air distribution.

Among other services, IPTV may offer on-demand services such as video on demand (VOD). A video on demand service permits a viewer to order a movie or other video program material for immediate viewing. In a typical video on demand system, the viewer is presented with a library of video choices. The VOD program material, such as movies, for example, are referred to herein as assets, programs or content. The viewer may be able to search for desired content by sorting the library according to actor, title, genre or other criteria before making a selection. In general, assets, programs and content include audio files, images and/or text as well as video.

In a typical VOD system, an application software component (known as the VOD client) resides in the set-top box (STB) at the viewer's home. A typical VOD system further includes a large number of service delivery points (e.g., VOD servers) throughout the network. The service delivery points store VOD content and generate the VOD video streams for subscribers. The video inventory in the VOD server may contain thousands of titles. As these inventories continue to grow it becomes more and more impractical to replicate the entire inventory at every service delivery point. Accordingly, some mechanism should be provided to intelligently place content in the network. In general there is a tradeoff between the costs involved with storing the content in multiple locations and the network bandwidth costs associated with transporting the assets among multiple locations. For instance, one way to manage this tradeoff is by locating less popular, relatively infrequency viewed content in a central facility whereas more popular, more frequently demanded content may be located at multiple delivery points that reside near the subscribers. However, when content is to be distributed throughout a network in this manner, a mechanism is needed to timely and reliably transport the content among the various service delivery points.

### BRIEF DESCRIPTION OF THE DRAWINGS

FIG. 1 shows one example of an end-to-end network architecture for providing IPTV on-demand services from a super headend (SHE) to multiple end users.

FIG. 2 is a simplified pictorial diagram illustrating the manner in which content servers such as the video hub offices in FIG. 1 can simultaneously stream and propagate content to an edge device such as the video switching offices in FIG. 1.

FIG. 3 is a flowchart showing one example of a process for transferring a media asset to an edge device such as a VSO.

FIG. 4 is a functional diagram of an edge device such as a VSO for illustrating the manner in which missing pieces of an asset are combined with the remainder of the asset.

### DETAILED DESCRIPTION

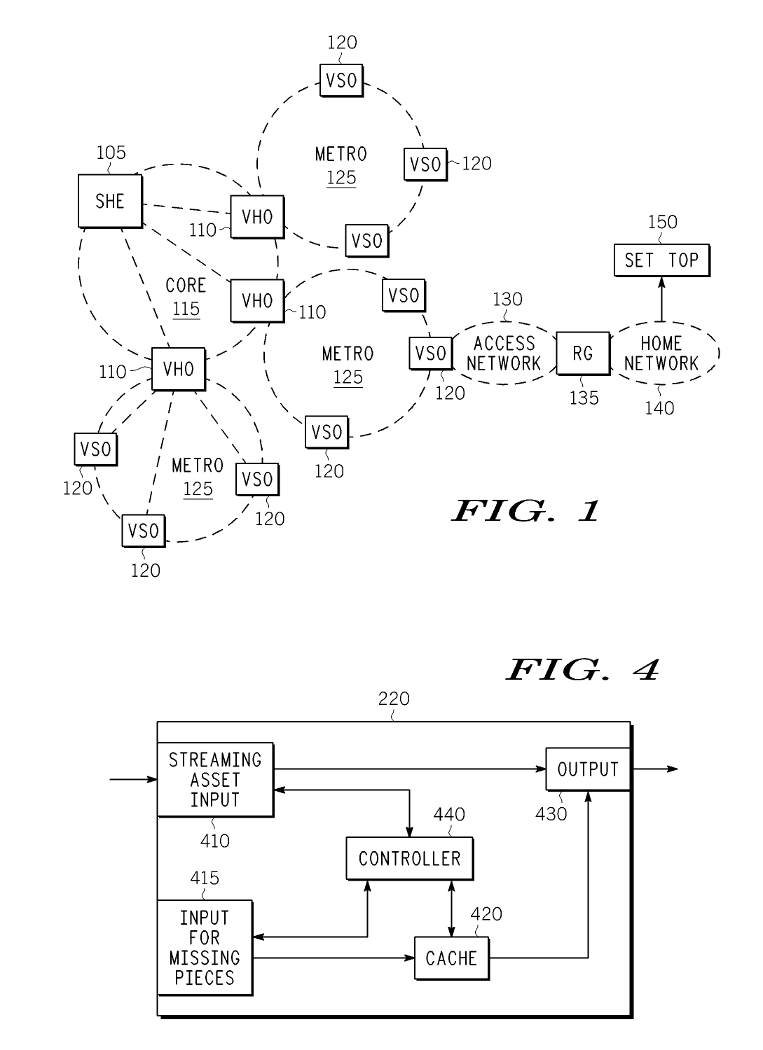

FIG. 1 shows one example of an end-to-end network architecture for providing IPTV on-demand services from a super headend (SHE) to multiple end users over one or more packet-switched networks. The topology employed in this example includes a three-level hierarchy: a large capacity core network, multiple metropolitan aggregation networks (configured as bidirectional rings in this example) and edge access networks. It should be emphasized that the network architecture shown in FIG. 1 is presented for illustrative purposes only. More generally, the techniques described herein are also applicable to other networks that include additional or fewer hierarchal levels, each of which may employ a wide range of different physical topologies including, but not limited to ring, tree, mesh and point-to-point networks. In addition, the various networks will generally include a variety of devices such as routers, gateways, bridges, ATM switches, frame relay switches, network management and control systems and the like, which are well-known components that need not be discussed in detail. SHE 105 serves as a central (e.g., national) location for acquisition and aggregation of broadcast, multicast, narrowcast and on-demand programming as well as other content. The SHE 105 typically contains real-time encoders used for broadcast video service and asset distribution systems for on-demand services. The video hub offices (VHOs) 110 serve as distribution points for regional areas, each of which typically cover a demographic market area. The VHOs 110 include video servers that receive content from the SHE 105, acquire and encode additional local content, and insert local advertising into the programming. Video pumps are also provided in the VHOs 110 to supply content for on-demand services. In some implementations VHOs may serve a metropolitan area of between about 100,000 and 1 million residences. The SHE 105 communicates with VHOs 110 over the core network 115, which may be, for example, an IP backbone network.

Video Switching Offices (VSOs) 120 are essentially central offices that contain aggregation routers for distributing content received from the VHOs 110 to an access network. In some cases the VSOs 120 may include local video pumps that are used to cache popular on-demand content in order to reduce bandwidth requirements between the VSOs 120 and the VHOs 110. Depending on the nature of the access network, the VSOs 120 may also include, for example, digital subscriber line access multiplexers (DSLAMs) in the case of DSL access networks or optical line terminators (OLTs) in the case of fiber-based access networks. The VSOs 120 communicate with one another and the VHOs 110 over metropolitan aggregation networks 125, which may be, for example, gigabit Ethernet-based networks. In this network architecture, the VSOs 120 serve as an example of an edge device that provides content to the subscriber from the on-demand network. Of course, in different network topologies other types of network nodes or entities may serve as the edge devices.

Access networks 130 provide the connectivity between the aggregation networks and a residential gateway 135 on the subscriber premises. Access network 130 may be, for example, a cable access network (e.g., coaxial network, HFC network), satellite network, broadband passive optical network (BPON), public-switched telephone network (PSTN) and the like. If the access network 130 is a cable access network, the edge device may include a QAM modulator. Residential gateway 135 provides traffic management and routing between the access network 130 and the subscriber's residential network 140 on which the on-demand client (e.g., a set top terminal 150) resides. Residential gateway 135 may include a broadband modem such as a cable or DSL modem, for example, depending on the type of access network 130 that is employed.

In operation, when a VHO 110 receives a request for an on-demand service from a client via a VSO, the VHO requests a video pump for the session. If the content needs to be encrypted in real time, the VHO 110 contacts a conditional access system (CAS) to request a real time encryption engine for the session. The CAS responds with the decryption keys to be used by the on-demand client to decrypt the video stream. After all the resources necessary for the on-demand session are obtained, the VHO responds to the on-demand client with any necessary information needed by the client to acquire the content stream. Such information may include transport parameters such as the network, transport and application level protocols used by the content stream. For instance, the content stream may use a particular combination of network, transport and application protocols such as IP/UDP/RTP, for example. If the content stream is encrypted, the response from the VHO can include a decryption key or keys as well. Finally, the VHO provides the IP address of the video pump that was selected for the session. The IP address of the video pump is needed by the on-demand client to send stream control requests (e.g., pause, fast-forward, rewind and other trick mode requests) using a protocol such as RTSP. In addition, a control protocol such as RSVP may be used with the aforementioned routing protocols to reserve resources (e.g., bandwidth) so as to deliver specific quality of service (QOS) levels for the content stream. Once the necessary information has been received by the on-demand client, the VHO 110 may begin streaming the content to the on-demand client.

As previously mentioned, the number of on-demand assets continues to grow at a rapid rate, thereby increasing the size of the content libraries residing at the SHE 105 and the VHOs 110. As a result it becomes more desirable to locate some of the more popular on-demand content at edge devices such as the VSOs 120 while less popular or so-called “long tail” content will continue to reside at the SHE 105 and possibly at the VHOs 110. For instance, it may be reasonable to assume that an on-demand asset that is streamed to one or more clients upon request is likely to be subsequently requested by other clients. In this case it may be more efficient if the asset resided at the VSO 120 so that it does not need to be streamed from the VHO 110 to the VSO 120 each and every time it is requested.

While an asset can be moved to the VSOs 120 or other edge device as part of the streaming process when the asset is requested during an on-demand session, this can sometimes be a problematic way to transfer content because not all of the information may be received by the VSO. For example, certain stream control requests that may be received from the client result in the asset being streamed at different playout rates. If the requested playout rate is faster than normal, a significant amount of information may be excluded from the content stream that is streamed to the client. For example, if the subscriber fast forwards through a program for a certain time interval at a rate of say, 12 times normal play, roughly only 1/12^{th} of the information will be streamed from the VHO to VSO and subsequently to the client in comparison to the amount of information that would otherwise be streamed during the same interval at the normal the playout rate. That is, in order for a content stream to maintain a constant bit rate at increased playout rates, the amount of information that is sent in that stream must be reduced. If the network were to send all the information while in 12 times fast forward mode, 12 times as much bandwidth would be required, which generally would be impractical. Accordingly, during fast forward the amount of information that is streamed to the VSO, and in turn to the on-demand client, is reduced commensurately so that no additional bandwidth is needed.

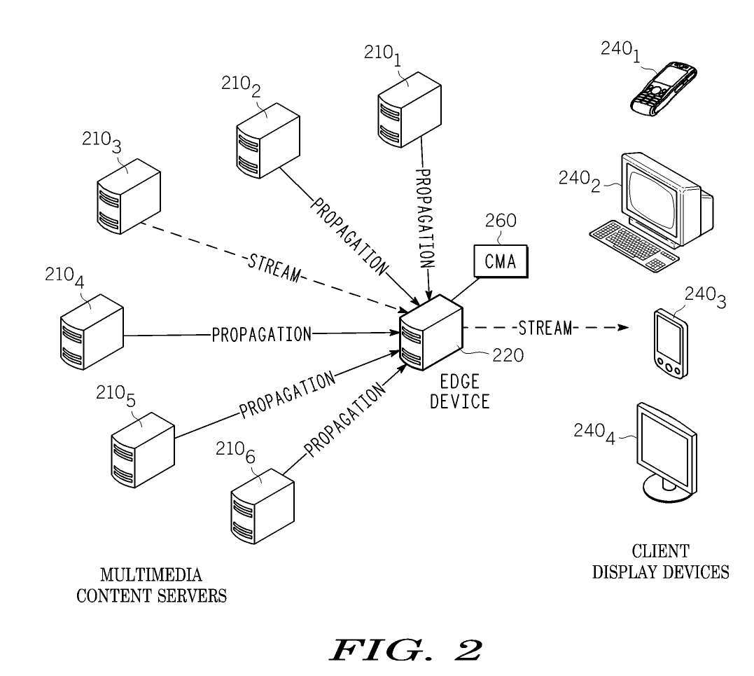

Because not all of the information may be streamed during an on-demand session because of stream control requests and the like, transferring an asset to the VSOs or other edge devices cannot be reliably achieved in this manner. For instance, to use an extreme example for purposes of illustration, if an asset were streamed in its entirety to a VSO or edge device at 12 times its normal playout rate, at the completion of the session the edge device would have only received 1/12 of the information available in that asset. To overcome this problem, when an on-demand asset is streamed to an edge device such as the VSO upon the request of an on-demand client, a separate and distinct process can be initiated in which the missing information is sent to the VSO using a content propagation model. FIG. 2 is a simplified pictorial diagram illustrating the manner in which content servers 210₁, 210₂, 210₃, 210₄, 210₅ and 210₆ (collectively “content servers 210”) can simultaneously stream and propagate content to an edge device 220. In the context of the network architecture depicted in FIG. 1, content servers 210 may correspond to the video servers located in the VHOs 110 and edge device 220 may correspond to the VSOs 120.

As shown in FIG. 2 and as described above, when an asset is requested by an on-demand client (e.g., any of on-demand clients 240₁, 240₂, 240₃ and 240₄), the asset is streamed from one of the content servers (e.g., content server 210₃) to the edge device, which in turn streams the asset to the client. That is, the stream provides the subscriber with the content that is to be viewed during the on-demand session. In addition, the edge device 220 caches the asset so that it is locally available when it is requested by other subscribers. Depending on the playout rate of the asset, the entire asset may or may not reside on the edge device 220. If not, then, as indicated in FIG. 2, the missing portions (e.g., blocks, pieces or tiles) may be propagated to the edge device 220 using any suitable file transfer protocol such as FTP, for example. That is, the edge device 220 sends out a request for the portions of the asset that are missing. In response, any of the content servers on which the asset resides may propagate one or more of the missing pieces to the edge device 220. The propagation of the missing pieces may occur simultaneous with or subsequent to the streaming of the asset. Transfer of the missing pieces of the asset in accordance with a content propagation transfer model shares the burden of transfer among multiple content servers 210 and relieves them of the real time constraints that are imposed when the asset is being streamed. Once the complete asset is cached at the edge device 220, the edge device 220 signals the content servers to inform them that the asset no longer needs to be streamed (and to cancel a stream for that asset if one is in progress) because the stream for the asset can now be generated in its entirety from the edge device 220.

As shown, the edge device 220 may include a content management agent (CMA) 260 to oversee and facilitate implementation of the transfer of assets from the content servers 210 and to the on-demand clients 240. Among other things, the CMAs 260 may be used to identify the missing pieces of any locally residing media assets and to instruct the content servers to transfer the missing pieces of the asset in accordance with a content propagation model. The missing pieces of the assets may be identified by any appropriate means. For example, if the asset is embodied in an MPEG transport stream, program specific information included in MPEG system tables may be used to identify the missing pieces.

Propagation of any missing pieces of an asset may or may not be initiated immediately upon the first occurrence of a request for that asset from an on-demand client 240. For instance, in some cases it only may be economical to transfer the entire asset to an edge device 220 after it has been requested by clients a threshold number of times. In this case the CMA in the edge device 220 can determine when the missing pieces of the asset should be sent and it can issue a propagation request to the content servers 210 at that time. That is, the edge device 220 (via its CMA) itself can make the decision as to when the asset should be locally resident. Alternatively, in some cases this decision can be made by the content servers using their own content management agents, discussed immediately below.

In addition to the edge devices, the content servers 210 (e.g., VHOs 110₁-110₄ in FIG. 1) may each include a content management agent (CMA) to oversee and facilitate implementation of the transfer of assets among themselves and to the edge device 220. Among other things, the content server CMAs may be used to instruct the content server to stream a requested asset to the edge device 220 or to transfer all or select pieces of the asset in accordance with a content propagation model such as a content delivery model (e.g, a client-server model) or a peer-to-peer file transfer model. In addition, when an asset is not locally available to a particular one of the content servers 210, its CMA may also be used to determine whether to have the asset sent to the subscriber from a central library (e.g., the SHE 105 in FIG. 1) or whether to obtain it from other content servers 210.

FIG. 4 shows a simplified functional diagram of an edge device 220 for the purpose of conceptualizing the manner in which missing pieces of the asset are combined with the remainder of the asset that has been streamed to the edge device. As shown, the streaming portion of the asset is received by the edge device on a first input 410. Likewise, the missing pieces of the asset are received by the edge device on a second input 415 and stored in a cache 420. When the asset is to be provided to a client, the streaming portion of the asset received on the first input 410 is output on the output 430. A controller 440 identifies the missing pieces of the content that is being received at the output 430 and inserts the missing pieces when appropriate by transferring them from the cache 420 to the output 430.

The network architecture and content transfer mechanism described above offers numerous benefits. For example, by distributing content in a hierarchical fashion more content can be made available to the subscribers than can be physically stored at the edge device. This allows less popular content to be offered without unduly increasing the costs associated with storing the content at multiple locations. Moreover, since the streaming content is buffered at the edge device before it is streamed to the client, the edge device can tightly control the jitter characteristics of the stream to the client. Since the edge device has control of the stream it can also support such features as local and individually customized ad insertion. Another advantage of the hierarchical network architecture presented above is that the overall topology need not be fully connected. In particular, an edge device needs to have reachability to each of the clients with which it is associated. However, the content servers (e.g., SHE 105 and VHOs 110 in FIG. 1) only need to have reachability to the edge devices, not the clients. In addition, propagation of any necessary pieces of the content to the edge device can be conducted without the need for real time transmission characteristics.

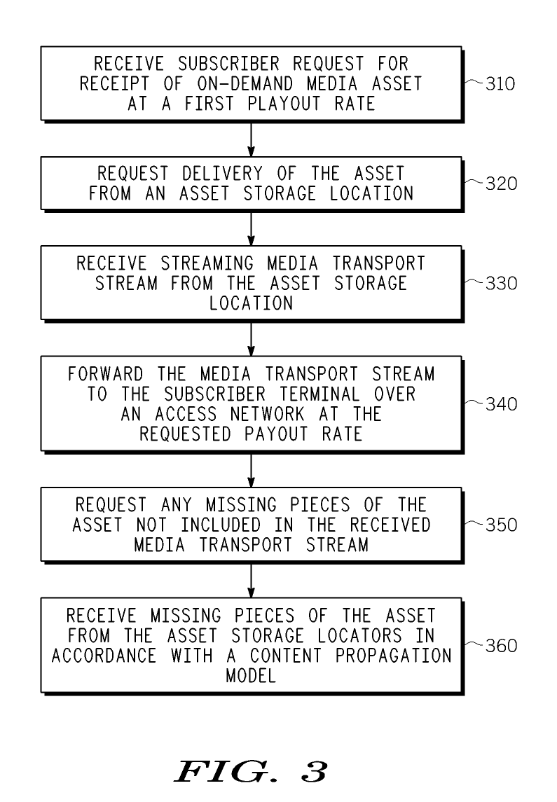

FIG. 3 is a flowchart showing one example of a process for transferring a media asset to an edge device such as the VSOs 120. The method begins in step 310 when the edge device receives from a subscriber terminal a request for receipt of an on-demand media asset at a first playout rate, which may be a fast-forward rate that is greater than the normal playout rate. In response to the first request, in step 320 the edge device requests delivery of the asset from an asset storage location such as one of the VHOs 110. The edge device receives a streaming media transport stream from the asset storage location in step 330. The streaming media transport stream embodies the pieces of the asset needed for it to be rendered at the playout rate (e.g., every 12^{th} frame) requested by the subscriber terminal. Next, in step 340 the media transport stream is forwarded to the subscriber terminal over an access network at the requested playout rate. In addition, in step 350, the VSO requests any missing pieces of the asset that were not included in the media transport stream that it received. In step 360 the missing pieces of the asset are received from at least one of the asset storage locations over the packet-switched network in accordance with a content propagation model.

The processes described above may be implemented in a general, multi-purpose or single purpose processor. Such a processor will execute instructions, either at the assembly, compiled or machine-level, to perform that process. Those instructions can be written by one of ordinary skill in the art following the description above and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized wireline or wireless transmission signals.

Although various embodiments and examples are specifically illustrated and described herein, it will be appreciated that modifications and variations are covered by the above teachings and are within the purview of the appended claims.

1. At least one computer-readable medium encoded with instructions which, when executed by a processor, performs a method including:
receiving from a subscriber terminal a first request for receipt of an on-demand media asset from an on-demand media delivery system at a first playout rate;
in response to the first request, requesting delivery of the asset from a first of a plurality of asset storage locations over a packet-switched network;
receiving from the storage location a streaming media transport stream embodying the asset at the playout rate requested by the subscriber terminal;
forwarding the media transport stream to the subscriber terminal over an access network at the requested playout rate;
requesting any missing pieces of the asset not included in the media transport stream that is received; and
receiving from at least one of the asset storage locations over the packet-switched network the missing pieces of the asset.

2. The computer-readable medium of claim 1 wherein the first request is received by a video switching office (VSO) and the first asset storage location is a video hub office (VHO) having at least one on-demand server.

3. The computer-readable medium of claim 1 further comprising requesting termination of the streaming media transport stream after all the missing pieces of the asset have been received.

4. The computer-readable medium of claim 3 further comprising:
receiving a second request for receipt of the on-demand media asset from a second subscriber terminal;
locally generating the streaming media transport stream; and
forwarding the locally generated transport stream to the second subscriber terminal.

5. The computer-readable medium of claim 1 wherein the subscriber terminal requests receipt of the media asset at a plurality of different playout rates over the course of an on-demand session.

6. The computer-readable medium of claim 1 wherein the media transport stream is forwarded to the subscriber terminal by an edge device.

7. The computer-readable medium of claim 6 wherein the edge device includes a QAM modulator.

8. The computer-readable medium of claim 1 wherein the request for any missing pieces of the asset is generated while the streaming media transport stream is being received.

9. The computer-readable medium of claim 1 wherein the request for any missing pieces of the asset is generated after the on-demand media asset has been requested by one or more subscriber terminals a threshold number of times.

10. The computer-readable medium of claim 1 wherein the missing pieces of the asset are received in accordance with a content propagation model.

11. An on-demand system, comprising:
a plurality of content storage nodes each having a content server on which reside media assets available to subscribers upon request;
at least one edge node in communication with the plurality of content storage nodes over a packet-switched network, the edge node being configured to provide on-demand services to the subscribers over an access network; and
a content management agent associated with the edge node, wherein the content management agent is configured to coordinate delivery to the edge node of any missing pieces of a media asset streamed to the edge node in response to a subscriber request.

12. The on-demand system of claim 11 wherein the content management agent is configured to coordinate delivery of the missing pieces of the media asset in accordance with a content delivery model.

13. The on-demand system of claim 12 wherein the configuration manager requests delivery of the missing pieces of the media asset only after it has been requested a threshold number of times by subscribers

14. The on-demand system of claim 11 wherein the plurality of content storage nodes includes at least two hierarchical levels of content storage nodes.

15. At least one computer-readable medium encoded with instructions which, when executed by a processor, performs a method including:
receiving a media transport stream embodying an on-demand media asset over a packet-switched network in response to an on-demand request for the media asset from a subscriber;
sending a request for delivery of any missing pieces of the asset not included in the media transport stream that is received; and
in response to the request, receiving at least one of the missing pieces of the asset over the packet-switched network.

16. The computer-readable medium of claim 15 wherein the missing pieces of the asset are received by an edge device from a video hub office (VHO).

17. The computer-readable medium of claim 16 wherein the edge device is a video switching office (VSO).

18. The computer-readable medium of claim 15 wherein the request for delivery of the missing pieces of the media asset is only sent after a threshold number of on-demand requests have been received for the media asset by subscribers.

19. The computer-readable medium of claim 15 wherein the missing pieces of the media asset are received in accordance with a content propagation model.

20. The computer-readable medium of claim 15 wherein the subscriber requests receipt of the media asset at a playout rate greater than a normal playout rate.
